(19) United States
(12) Patent Application Publication
(10) Pub. No.: US 2024/0274802 A1
(43) Pub. Date: Aug. 15, 2024

(54) NEGATIVE ELECTRODE FOR RECHARGEABLE LITHIUM BATTERY AND RECHARGEABLE LITHIUM BATTERY INCLUDING SAME

(71) Applicant: SAMSUNG SDI CO., LTD., Yongin-si (KR)

(72) Inventors: Junkyu LEE, Yongin-si (KR); Hana YOO, Yongin-si (KR); Uisong DO, Yongin-si (KR); Jinhyuk IN, Yongin-si (KR); Hyeri EOM, Yongin-si (KR); DongHun LEE, Yongin-si (KR); Wonhyung CHAE, Yongin-si (KR)

(21) Appl. No.: 18/453,790

(22) Filed: Aug. 22, 2023

(30) Foreign Application Priority Data
Feb. 6, 2023 (KR) 10-2023-0015777

(51) Int. Cl. H01M 4/36; H01M 4/133; H01M 4/134; H01M 4/38; H01M 4/587; H01M 10/052

(52) U.S. Cl. CPC H01M 4/366; H01M 4/133; H01M 4/134; H01M 4/364; H01M 4/386; H01M 4/587; H01M 10/052; H01M 2004/021; H01M 2004/027

(57) ABSTRACT

A negative electrode for a rechargeable lithium battery and a rechargeable lithium battery including the same are provided. The negative electrode for the rechargeable lithium battery includes a current collector, a first negative active material layer on at least one surface of the current collector; and a second negative active material layer on the first negative active material layer, wherein the first negative active material layer is a non-oriented layer, the second negative active material layer is oriented layer, a DD (Degree of Divergence) value of the first negative active material layer and a DD value of the second negative active material layer have a relationship expressed in Equation 1 and the DD value is defined by Equation 2.

### CROSS-REFERENCE TO RELATED APPLICATION

This application claims priority to and the benefit of Korean Patent Application No. 10-2023-0015777 filed in the Korean Intellectual Property Office on Feb. 6, 2023, the entire content of which is hereby incorporated by reference.

### BACKGROUND

### 1. Field

Embodiments of the present disclosure relate to a negative electrode for a rechargeable lithium battery and a rechargeable lithium battery including the same.

### 2. Description of the Related Art

Rechargeable lithium batteries, which have recently drawn attention as power sources for small portable electronic devices, use organic electrolyte solutions and thereby, have discharge voltages (and, accordingly, energy densities) at least twice as high as batteries of the related art that use alkali aqueous solutions.

As the negative active material for rechargeable lithium batteries, the search for a silicon negative active material with a high discharge specific capacity of 3400 mAh/g, which is capable of rapidly bonding to lithium ions and enabling fast charging and discharging, has been actively undertaken.

However, silicon contracts and expands during charging and discharging, causing cracks to form, which can lead to the deterioration of the life-cycle characteristics.

### SUMMARY

Aspects of one or more embodiments of the present disclosure are directed toward a negative electrode for a rechargeable lithium battery exhibiting high energy density and improved expansion characteristics.

Aspects of one or more embodiments of the present disclosure are directed toward a rechargeable lithium battery including the negative electrode.

Additional aspects will be set forth in part in the description which follows and, in part, will be apparent from the description, or may be learned by practice of the presented embodiments of the disclosure.

One or more embodiments of the present disclosure provides a negative electrode for a rechargeable lithium battery including a current collector, a first negative active material layer on at least one surface of the current collector; and a second negative active material layer on the first negative active material layer, wherein the first negative active material layer is a non-oriented layer, the second negative active material layer is an oriented layer, a DD (Degree of Divergence) value of the first negative active material layer and a DD value of the second negative active material layer have a relationship expressed in Equation 1: Equation 1: A≥10, wherein in Equation 1, A is the DD value of the second negative active material layer—(minus) the DD value of the first negative active material layer; and wherein the DD value is defined by Equation 2: Equation 2: DD (Degree of Divergence)=(Iₐ/Iₜₒₜₐₗ)*100; wherein in Equation 2, Iₐ is a sum of peak intensities at non-planar angles measured by XRD utilizing a CuKα ray, and, Iₜₒₜₐₗ is a sum of peak intensities at all angles measured by XRD utilizing a CuKα ray.

In one or more embodiments, A may be about 10 to about 40.

In one or more embodiments, the first negative active material layer may have a DD value of less than about 30, or the first negative active material layer may have a DD value of less than about 30, and about 10 or more.

In one or more embodiments, the second negative active material layer may have a DD value of about 30 or more, or the second negative active material layer may have a DD value of about 30 to about 60.

In one or more embodiments, the first negative active material layer may have a thickness of about 10 μm to about 30 μm.

In one or more embodiments, the Iₐ may be the sum of peak intensities at 2θ=42.4±0.2°, 43.4±0.2°, 44.6±0.2°, and 77.5±0.2° measured by XRD utilizing the CuKα ray, and the Iₜₒₜₐₗ may be the sum of peak intensities at 2θ=26.5±0.2°, 42.4±0.2°, 43.4±0.2°, 44.6±0.2°, 54.7±0.2°, and 77.5±0.2° measured by XRD utilizing the CuKα ray.

In one or more embodiments, the peak intensities may be peak integral area values.

In one or more embodiments, the first negative active material layer or second negative active material may include a crystalline carbon-based negative active material.

In one or more embodiments, the first negative active material layer or the second negative active material layer may include a crystalline carbon-based negative active material and a Si-based negative active material. Herein, a mixing ratio of the crystalline carbon-based negative active material and the Si-based negative active material may be about 98:2 to about 90:10 in a weight ratio.

In one or more embodiments, the Si-based negative active material may be Si, a Si—C composite, SiOₓ (0<x<2), Si-Q alloy (wherein Q is an element of (e.g., selected from) an alkali metal, an alkaline-earth metal, a Group 13 element, a Group 14 element, a Group 15 element, a Group 16 element, a transition metal, a rare earth element, and/or a combination thereof but not Si), or a combination thereof.

According to one or more embodiments of the present disclosure, a rechargeable lithium battery includes the negative electrode, a positive electrode including a positive active material, and a non-aqueous electrolyte.

One or more embodiments of the present disclosure are included in the following detailed description.

A negative electrode for a rechargeable lithium battery according to one or more embodiments may exhibit high energy density and the improved expansion characteristics.

### BRIEF DESCRIPTION OF THE DRAWINGS

FIG. 1 is a schematic view showing orientations according to one or more embodiments of the present disclosure.

FIG. 2 is a schematic view of orientations of the negative electrode according to one or more embodiments of the present disclosure.

FIG. 3 is a schematic diagram showing the process for providing the orientation in a negative electrode preparation according to one or more embodiments of the present disclosure.

FIG. 4 is a schematic perspective view showing a structure of a rechargeable lithium battery according to one or more embodiments of the present disclosure.

FIG. 5 is an image showing the separation of the negative electrode after fully-charging the rechargeable lithium cell, according to Comparative Example 2.

### DETAILED DESCRIPTION

The present disclosure may be modified in many alternate forms, and thus specific embodiments will be illustrated in the drawings and described in more detail. It should be understood, however, that this is not intended to limit the present disclosure to the particular forms disclosed, but rather, is intended to cover all modifications, equivalents, and alternatives falling within the spirit and scope of the present disclosure.

The embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described.

Unless otherwise noted, like reference numerals denote like elements throughout the attached drawings and the written description, and thus, duplicative descriptions thereof may not be provided. In the drawings, the relative sizes of elements, layers, and regions may be exaggerated for clarity.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise.

The term “combination thereof” may include a mixture, a laminate, a complex, a copolymer, an alloy, a blend, and/or a reactant of constituents.

It will be further understood that the terms “comprises,” “comprising,” “includes,” “including,” “have,” “having,” when used in this specification, specify the presence of the stated features, integers, steps, operations, elements, and/or components, but do not preclude the presence or addition of one or more other features, integers, steps, operations, elements, components, and/or groups thereof.

Expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from a, b, and c,” “at least one from among a, b, and c,” “one from among a, b, and c”, “at least one of a to c” indicates only a, only b, only c, both a and b, both a and c, both b and c, all of a, b, and c, or variations thereof.

It will be understood that, although the terms “first,” “second,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

Spatially relative terms, such as “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Unless otherwise defined in the specification, when an element, such as a layer, a film, a region, a plate, and/or the like is referred to as being “on” or “over” another part, it may include cases where it is “directly on” another element, but also cases where there is another element in between. In addition, it will also be understood that when an element or layer is referred to as being “between” two elements or layers, it can be the only element or layer between the two elements or layers, or one or more intervening elements or layers may also be present.

In the specification, the term “A and/or B” includes “A or B, or both A and B.”

When an element, such as a layer, a film, a region, a plate, and/or the like is referred to as being “on” or “over” another part, it may include cases where it is “directly on” another element, but also cases where there is another element in between. In contrast, when an element is referred to as being “directly on” another element, there are no intervening elements present.

In the present disclosure, when particles are spherical, “diameter” indicates a particle diameter or an average particle diameter, and when the particles are non-spherical, the “diameter” indicates a major axis length or an average major axis length.

When a definition is not otherwise provided in the specification, an average particle diameter indicates an average particle diameter (D50) where a cumulative volume is about 50 volume % in a particle distribution. The average particle diameter (D50) may be measured by a method generally available to those skilled in the art, for example, by a particle size analyzer, or by a transmission electron microscopic image, a scanning electron microscopic, or field emission scanning electron microscopy (FE-SEM). Alternatively, a dynamic light-scattering measurement device may be utilized to perform a data analysis, and the number of particles is counted for each particle size range, and from this, the average particle diameter (D50) value may be easily obtained through a calculation, or a laser diffraction method. The laser diffraction may be obtained by distributing particles to be measured in a distribution solvent and introducing it to a commercially available laser diffraction particle measuring device (e.g., MT 3000 available from Microtrac, Ltd.), irradiating ultrasonic waves of about 28 kHz at a power of 60 W, and calculating an average particle diameter (D50) in the 50% standard of particle distribution in the measuring device.

A negative electrode for a rechargeable lithium battery according to one or more embodiments includes a current collector; a first negative active material layer positioned on at least one surface of the current collector; and a second negative active material layer positioned on the first negative active material layer. The first negative active material layer is a non-oriented layer and the second negative active material layer is an oriented layer. A DD (Degree of Divergence) value of the first negative active material layer and a DD value of the second negative active material layer have a relationship expressed in Equation 1. Herein, the DD value is defined by Equation 2.

$$A \geq 10 \qquad Equation 1$$

In Equation 1, A is the DD value of the second negative active material layer−(minus) the DD value of the first negative active material layer (i.e., A=the DD value of the second negative active material layer—the DD value of the first negative active material layer).

$$DD ( Degree of Divergence ) = ( {I}_{a} / {I}_{total} ) * 100 \qquad Equation 2$$

In Equation 2, Iₐ is a sum of peak intensities at non-planar angles measured by XRD utilizing a CuKα ray, and Iₜₒₜₐₗ is a sum of peak intensities at all angles measured by XRD utilizing a CuKα ray.

The non-planar angles denote 2θ=42.4±0.2°, 43.4±0.2°, 44.6±0.2°, and 77.5±0.2° when measured by XRD utilizing a CuKα ray, that is, a (100) plane, a (101)R plane, a (101)H plane, and a (110) plane. In general, graphite has a structure classified into a rhombohedral structure and a hexagonal structure having an ABAB type or kind of stacking sequence according to a stacking order of graphene layers, and the R plane denotes the rhombohedral structure, while the H plane denotes the hexagonal structure.

Thus, the Iₐ may be a sum of peak intensities at 2θ=42.4±0.2°, 43.4±0.2°, 44.6±0.2°, and 77.5±0.2° measured by XRD utilizing a CuKα ray.

The all angles denote 2θ=26.5±0.2°, 42.4±0.2°, 43.4±0.2°, 44.6±0.2°, 54.7±0.2°, and 77.5±0.2° when measured by XRD utilizing a CuKα ray, that is, a (002) plane, a (100) plane, a (101)R plane, a (101)H plane, a (004) plane, and a (110) plane. A peak at 2θ=43.4±0.2° may also be considered to appear by overlapping a peak of a (101)R plane of a carbon-based material with another peak of a (111) plane of a current collector, for example, Cu.

Thus, the Iₜₒₜₐₗ may be a sum of peak intensities at 2θ=26.5±0.2°, 42.4±0.2°, 43.4±0.2°, 44.6±0.2°, 54.7±0.2°, and 77.5±0.2° measured by XRD utilizing a CuKα ray.

In general, peak intensity indicates a height of a peak or an integral area of the peak, and according to one or more embodiments, the peak intensity may indicate the integral area of a peak.

In one or more embodiments, the XRD is measured under a measurement condition of 2θ=10° to 80°, a scan speed (°/S) of 0.044 to 0.089, and a step size (°/step) of 0.013 to 0.039 by utilizing a CuKα ray as a target ray but removing a monochromator to improve a peak intensity resolution.

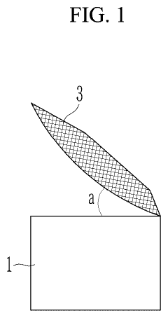

The DD values indicates that the negative electrode active material included in the negative active layer are oriented at a set or predetermined angle, and a larger value indicates that the negative electrode active material is well oriented. For example, as schematically shown in FIG. 1, as the DD values is increased, an angle (a) is increased if the negative active material 3 is oriented to one side of the substrate with the angle (a). Furthermore, the DD value is maintained after charges and discharges.

In one or more embodiments, the first negative active material layer is a non-oriented layer, the second negative active material layer is an oriented layer, and an A expressed in Equation 1 may be about 10 or more. For example, the DD value of the second negative active material layer may be 10 or more higher than the DD value of the first negative active material layer. According to one or more embodiments, in Equation 1, the A may be about 10 to about 40, or about 10 to about 30.

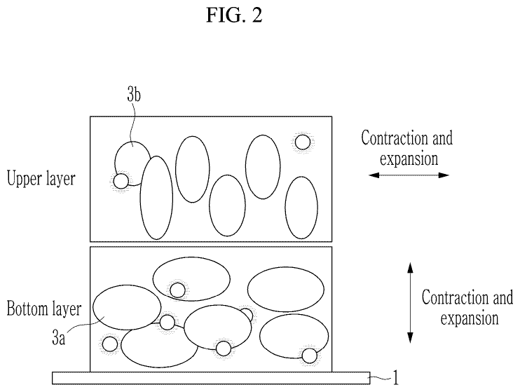

In the negative electrode according to one or more embodiments, the expansion and the orientation of the first negative active material layer and the second negative active material layer are illustrated with reference to FIG. 2. The first negative active material layer (e.g., bottom layer) is a non-oriented layer, that is, a negative active material 3a is substantially horizontally and parallel to the current collector 1, so that the expansion of the negative electrode may occur in a vertical direction during charging and discharging of the battery, and the secondary negative active material layer (e.g., upper layer) is the oriented layer which indicates the negative active material 3b stands vertically relative to the current collector 1, so that the expansion of the negative electrode may occur in a horizontal and parallel direction during charging and discharging of the battery. In FIG. 2, small circles included in the upper layer and the bottom layer may indicate a binder (or conductive material) included in the negative active material layer, which may or may not be critical configuration for the orientation description depending on the embodiment, and thus, the description therefor may be limited but should not be construed as limiting the scope of the present disclosure.

Accordingly, if the rechargeable lithium battery including the negative electrode is charged and discharged, the first negative active material layer contacted with the current collector may be substantially and vertically expanded and the second negative active material layer may be horizontally expanded. Resultantly, based on the entire active material layer, the volume expansion may be effectively suppressed or reduced during charge and discharge of the battery, which may reduce the increase rate in thickness and prevent or reduce the separation of the active material layer from the current collector.

Such effects from the expansion direction of the first negative active material layer and the second negative active material layer may be more effectively obtained if the A value expressed in Equation 1 is about 10 or more, or about 10 to about 40, for example, about 10 to about 30. If the A value is less than 10, the effect for reducing expansion may be not realized.

The first negative active material layer and the second negative active material layer may include a crystalline carbon-based negative active material as a negative active material, and according to one or more embodiments, may include a crystalline carbon-based negative active material and a Si-based negative active material.

By including the crystalline carbon-based negative active material and the Si-based negative active material as the negative active material, the effects obtained by adjusting the expansion direction according to the position of the first negative active material layer and the second negative active material layer described above may be increased. By utilizing the Si-based negative active material, the expansion mainly occurs in a horizontal direction to the current collector, which mainly causes the negative active material layer to separate from the current collector. As described above, the negative active material according to one or more embodiments may more effectively suppress or reduce the separation of the Si-based negative active material in the horizontal direction, as the first negative active material directly contacting the current collector is substantially expanded in the vertical direction.

If the first negative active material layer and the second negative active material layer are both oriented layers, the first and second negative active material layer may be both expanded in the horizontal direction, which may cause the negative active material layer to separate, which is not appropriate or suitable. Furthermore, if the first negative active material layer is an oriented layer and the second negative active material layer is a non-oriented layer, the first negative active material layer may be horizontally expanded, which may cause the separation of the negative active material layer from the current collector.

In one or more embodiments, the crystalline carbon-based active material may be unspecified shaped, sheet-shaped, flake-shaped, spherically-shaped, fiber-shaped artificial graphite, natural graphite, and/or combinations thereof.

The Si-based negative electrode active material may be Si, a Si—C composite, SiOₓ (0<x<2), Si-Q alloy (wherein Q is an element of (e.g., selected from) an alkali metal, an alkaline-earth metal, a Group 13 element, a Group 14 element, a Group 15 element, a Group 16 element, a transition metal, a rare earth element, and/or a combination thereof, but not Si), or a combination thereof.

The Si—C composite may include Si and a carbon-based material. The carbon-based material may be amorphous carbon or crystalline carbon. The composite, for example, may include a core including Si particles and a carbon-based material around (e.g., surrounding) the core. The core may further include a carbon-based material. For example, the Si—C composite may include a core in which Si particles and a first carbon-based material are mixed, and a second carbon-based material around (e.g., surrounding) the core. The first carbon-based material and the second carbon-based material may be the same or different from each other, and may be amorphous carbon or crystalline carbon. Examples of the composite may include a secondary particle in which at least one of Si nano particle primary particles and/or crystalline carbon are agglomerated, i.e, an agglomerated product, an amorphous carbon coating layer around (e.g., surrounding) the agglomerated product, and amorphous carbon filled between the agglomerated products collocated with and around (e.g., surrounding) the primary particles.

The Si may have a particle diameter of about 10 nm to about 30 μm, and according to one or more embodiments, may have a diameter of about 10 nm to about 1000 nm, or may have a diameter of about 20 nm to about 150 nm. If the average particle diameter of the Si particle is within the above ranges, the volume expansion caused during charge and discharge may be suppressed or reduced, and a breakage of the conductive path due to crushing of particles during charge and discharge may be prevented or reduced.

In one or more embodiments, the mixing ratio (e.g., weight ratio) of the crystalline carbon-based negative active material and the Si-based negative active material may be about 98:2 to about 95:5, or about 93:7 to about 90:10. If the mixing ratio of the crystalline carbon-based negative active material and the Si-based negative active material is within these ranges, the higher capacity and higher energy density effect may be obtained.

The amorphous carbon may be pitch carbon, soft carbon, hard carbon, mesophase pitch carbide, sintered cokes, carbon fiber, or a combination thereof, and the crystalline carbon may be unspecified-shaped, sheet-shaped, flake-shaped, spherically-shaped, fiber-shaped natural graphite, artificial graphite, or a combination thereof.

In one or more embodiments, the first negative active material layer, the non-oriented layer, may have a DD value of less than about 30, or less than about 30 and about 10 or more. The second negative active material layer may have a DD value of about 30 or more, or the second negative active material layer may have a DD value of about 30 to 60.

The first negative active material layer with a DD value of more than 30, may not exhibit effects derived from vertical expansion of a non-oriented later. Furthermore, if a DD value of the second negative active material layer is less than 30, the second negative active material layer corresponds to a non-oriented layer, or even if the second negative active material layer is an oriented layer, the effects related to expansion are minimal.

In one or more embodiments, the DD value is obtained by charging and discharging a rechargeable lithium battery including the negative electrode, disassembling the battery when fully discharged to obtain the negative electrode, and measuring an XRD about the negative electrode. Herein, the charge and discharge are once or twice performed at about 0.1 C to about 0.2 C. The DD value of the first active material layer is obtained by taking off the negative active material layer utilizing a tape after charge and discharge and measuring an XRD of the active material layer attached to the current collector.

In one or more embodiments, a thickness of the first negative active material layer may be about 10 μm to about 30 μm. The first negative active material layer with the thickness within this range may have advantageous adhesion properties. The thickness may be a thickness of one side of the first negative active material layer. For example, the thickness may be a thickness of the first negative active material layer on one side of the current collector. If the first negative active material layers are formed on both sides of the current collector, the entire thickness of the first negative active material layer included in the negative electrode may be about 20 μm to about 60 μm.

The thickness of the first negative active material layer refers to a thickness after compressing and vacuum-drying in the negative electrode preparation. The vacuum-drying may be performed under a pressure of about 0.03 atm to about 0.06 atm at about 100° C. to about 160° C.

In one or more embodiments, the thickness of the second negative active material layer may be suitably controlled or selected, but the present disclosure is not limited thereto.

In the first and the second negative active material layers, the amount of the first and the second negative active materials may be about 95 wt % to about 99 wt % based on the total weight of each layer, and resultantly, it may be about 95 wt % to about 99 wt % based on the total weight of the negative active material layer.

The first and the second negative active material layers may include a binder, and may further include a conductive material. In the first and second negative active material layers, each amount of the binder may be about 1 wt % to about 5 wt % based on the total weight of each negative active material layer. Furthermore, if the conductive material is further included, about 90 wt % to about 98 wt % of the negative active material, about 1 wt % to about 5 wt % of the binder, and about 1 wt % to about 5 wt % of the conductive material, may be included.

The binder improves binding properties of negative active material particles with one another and with a current collector. The binder may be a non-aqueous binder, an aqueous binder, or a combination thereof.

The non-aqueous binder may be polyvinylchloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

The aqueous binder may be a styrene-butadiene rubber, an acrylated styrene-butadiene rubber, acrylonitrile-butadiene rubber, an acryl rubber, a butyl rubber, an ethylene propylene copolymer, polyepichlorohydrin, polyphosphazene, polyacrylonitrile, polystyrene, an ethylene propylenediene copolymer, polyvinyl pyridine, chlorosulfonated polyethylene, latex, a polyester resin, an acryl resin, a phenol resin, an epoxy resin, polyvinyl alcohol, an acrylate-based resin, or a combination thereof.

If the aqueous binder is utilized as a negative electrode binder, a cellulose-based compound may be further utilized to provide viscosity as a thickener. The cellulose-based compound includes one or more of carboxymethyl cellulose, hydroxypropylmethyl cellulose, methyl cellulose, or alkali metal salts thereof. The alkali metal may be Na, K, or Li. The thickener may be included in an amount of about 0.1 parts by weight to about 3 parts by weight based on 100 parts by weight of the negative electrode active material. Furthermore, the thickener may act as the binder.

The conductive material is included to provide electrode conductivity, and any electrically conductive material may be utilized as a conductive material unless it causes a chemical change. Examples of the conductive material may be a carbon-based material such as natural graphite, artificial graphite, carbon black, acetylene black, ketjen black, a carbon fiber, and/or the like; a metal-based material of a metal powder or a metal fiber including copper, nickel, aluminum, silver, and/or the like; a conductive polymer such as a polyphenylene derivative; or a mixture thereof.

The current collector may include one of (e.g., one selected from) a copper foil, a nickel foil, a stainless steel foil, a titanium foil, a nickel foam, a copper foam, a polymer substrate coated with a conductive metal, and/or a combination thereof, but the present disclosure is not limited thereto.

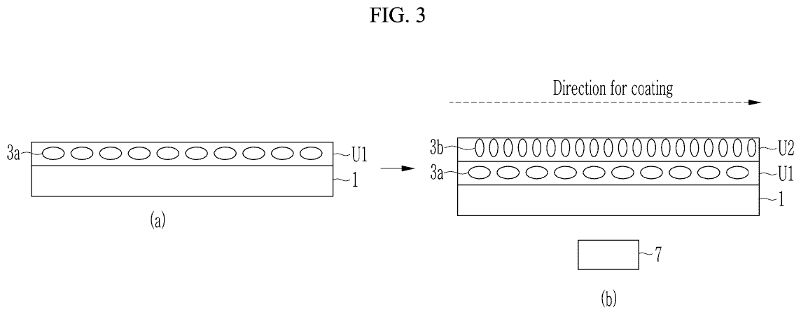

The negative electrode according one or more embodiments may be prepared by applying a magnetic field if a negative active material composition is coated on a current collector. The negative electrode active material layer preparation will be described in more detail with reference to FIG. 3.

As shown in FIG. 3, first, a first negative active material layer composition including a first negative active material 3a is coated on a current collector 1 and dried to prepare a first negative active material layer U1(a). As the coating of the first negative active material layer composition is performed without utilizing a magnet, the first negative active material layer is formed as a non-oriented layer. Thereafter, a magnet 7 is positioned under a current collector 1 in which the first negative active material layer U1 is formed, a second negative active material layer composition including a second negative active material 3b is coated on thereon and dried to prepare a second negative active material layer U2. The coating of the second negative active material layer composition is performed by moving the current collector in the direction of coating while the magnet is positioned under the current collector. Accordingly, the magnetic field (magnetic flux) by the magnet is formed vertically with the current collector, but the magnetic field, depending on the coating speed (a speed of moving the current collector), is formed at a set or predetermined angle as a vector function. Thus, the carbon-based negative active material included in the second negative active material layer composition stands, that is, may be oriented at the set or predetermined angle to the current collector, and resultantly, the second negative active material layer is formed as an oriented layer.

If the first negative active material layer and the second negative active material layer composition are formed on both sides of the current collector, the first negative active material layer is formed on one side of the current collector; the other first negative active material layer is formed on the corresponding side where the first active material layer is not formed, opposite to the side where the first negative active material layer is formed; and second negative active material layers are formed on the two first negative active material layers. In one or more embodiments, a first negative active material layer and a second negative active material layer may be sequentially formed on one side of the current collector, and a first negative active material layer and a second negative active material layer may be sequentially formed on other side corresponding to the opposite side of the current collector (e.g., the side opposite the side on which the first negative active material layer and a second negative active material layer were first formed).

The magnet may have strength of a magnetic field of about 1000 Gauss to about 10000 Gauss. In one or more embodiments, the negative active material composition may be coated on the current collector and maintained for about 3 seconds to about 15 seconds, that is, may be exposed to the magnetic field for about 3 seconds to about 15 seconds. In one or more embodiments, the time for exposing to the magnetic field may be about 3 seconds to about 12 seconds. Depending on the time for exposing to the magnetic field, the obtained DD value may be varied.

Furthermore, the DD value may be also obtained by adjusting a viscosity of the second negative active material layer composition.

The viscosity of the second negative active material layer composition may be about 2000 cps to about 4000 cps, about 2000 cps to about 3500 cps, or about 2500 cps to about 3500 cps at room temperature (about 20° C. to about 25° C.).

Furthermore, the viscosity of the first negative active material layer composition may be about 2000 cps to about 4000 cps, about 2000 cps to 3500 cps, or about 2000 cps to about 2500 cps at room temperature (about 20° C. to about 25° C.).

The viscosities of the first negative active material layer composition and the second negative active material layer composition may be controlled or selected within the above ranges.

If the viscosities of the first negative active material layer composition and the second negative active material layer composition satisfy the above ranges, the first negative active material layer and the second negative active material layer with the desired or suitable DD values and the difference of the DD values may be obtained. If the viscosity of the second negative active material layer composition is lower than the above ranges, an extreme increase in a degree of vertically of the crystalline carbon-based negative active material included in the second negative active material layer may cause a poor contact with the negative active material particles, and thus, the electron transference resistance may be increased, whereas higher viscosity than the above ranges may fade or reduce the effect from orientation, thereby reducing the impregnability of the electrolyte.

The first negative active material layer composition and the second negative active material composition, respectively, may be prepared by mixing the negative active material, a binder and a conductive material in a solvent.

The solvent may be an organic solvent such as N-methyl pyrrolidone, or water, and if the aqueous binder is utilized as the binder, the solvent may be water.

A rechargeable lithium secondary battery according to one or more embodiments includes the negative electrode, a positive electrode, and an electrolyte.

The positive electrode may include a current collector and a positive active material layer formed on the current collector.

The positive electrode active material may include lithiated intercalation compounds that reversibly intercalate and deintercalate lithium ions, and for example, one or more composite oxides of a metal of (e.g., a metal selected from) cobalt, manganese, nickel, and/or a combination thereof, and lithium may be utilized. For example, the compounds represented by one of the following chemical formulae may be utilized: LiₐA_{1-b}XbD¹₂ (0.90≤a≤1.8, 0≤b≤0.5); LiₐA_{1-b}XbO_{2-c1}D¹_{c1} (0.90≤a≤1.8, 0≤b≤ 0.5, 0≤c1≤0.05); LiₐE_{1-b}XbO_{2-c1}D¹_{c1} (0.90≤a≤1.8, 0≤b≤0.5, 0≤c1≤0.05); LiₐE_{2-b}X_{b}O_{4-c1}D¹_{c1} (0.90≤a≤1.8, 0≤b≤0.5, 0≤c1≤0.05); LiₐNi_{1-b-c}CO_{b}X_{c}D¹_{α} (0.90≤a≤1.8, 0≤b≤0.5, 0≤c≤0.5, 0<α≤2); LiₐNi_{1-b-c}CO_{b}X_{c}O_{2-α}T_{α} (0.90≤a≤1.8, 0≤b≤0.5, 0≤c≤0.5, 0<α<2); LiₐNi_{1-b-c}CO_{b}X_{c}O_{2-α}T₂ (0.90≤a≤1.8, 0≤b≤0.5, 0≤c≤0.5, 0<α≤2); LiₐNi_{1-b-c}Mn_{b}X_{c}D¹_{α} (0.90≤a≤ 1.8, 0≤b≤0.5, 0≤c≤0.5, 0<α≤2); LiₐNi_{1-b-c}Mn_{b}X_{c}O_{2-α}T_{α} (0.90≤a≤1.8, 0≤b≤0.5, 0≤c≤ 0.5, 0<α<2); LiₐNi_{1-b-c}Mn_{b}X_{c}O_{2-α}T₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}CO_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1) LiₐCoG_{b}O₂ (0.90≤a≤1.8, 0.001≤b≤0.1) LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li_{(3-f)}J₂(PO₄)₃ (0≤f≤2); Li_{(3-f)}Fe₂(PO₄)₃ (0≤f≤2); LiₐFePO₄ (0.90≤a≤1.8).

In the above chemical formulae, A is (e.g., is selected from) Ni, Co, Mn, and/or combinations thereof; X is (e.g., is selected from) Al, Ni, Co, Mn, Cr, Fe, Mg, Sr, V, a rare earth element, and/or combinations thereof; D¹ is (e.g., is selected from) O, F, S, P, and/or combinations thereof; E is (e.g., is selected from) Co, Mn, and/or combinations thereof; T is (e.g., is selected from) F, S, P, and/or combinations thereof; G is (e.g., is selected from) Al, Cr, Mn, Fe, Mg, La, Ce, Sr, V, and/or combinations thereof; Q is (e.g., is selected from) Ti, Mo, Mn, and/or combinations thereof; Z is (e.g., is selected from) Cr, V, Fe, Sc, Y, and/or combinations thereof; J is (e.g., is selected from) V, Cr, Mn, Co, Ni, Cu, and/or combinations thereof; L¹ is (e.g., is selected from) Mn, Al and/or combinations thereof.

Also, the compounds may have a coating layer on the surface, or may be mixed with another compound having a coating layer. The coating layer may include at least one coating element compound of (e.g., selected from the group consisting of) an oxide of a coating element, a hydroxide of a coating element, an oxyhydroxide of a coating element, an oxycarbonate of a coating element, and/or a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by utilizing these elements in the compound, and for example, the method may include any coating method such as spray coating, dipping, and/or the like, but is not described in more detail because it is generally available in the related field.

In the positive electrode, an amount of the positive active material may be about 90 wt % to about 98 wt % based on the total weight of the positive active material layer.

In one or more embodiments, the positive active material layer may further include a binder and a conductive material. Herein, the binder and the conductive material may be included in an amount of about 1 wt % to about 5 wt %, respectively based on the total amount of the positive active material layer.

The binder improves binding properties of positive active material particles with one another and with a current collector. Examples of the binder may be polyvinyl alcohol, carboxylmethyl cellulose, hydroxypropyl cellulose, diacetyl cellulose, polyvinylchloride, carboxylated polyvinylchloride, polyvinyl fluoride, an ethylene oxide-containing polymer, polyvinyl pyrrolidone, polyurethane, polytetrafluoroethylene, polyvinylidene fluoride, polyethylene, polypropylene, styrene-butadiene rubber, acrylated styrene-butadiene rubber, an epoxy resin, nylon, and/or the like, but the present disclosure is not limited thereto.

The conductive material is included to provide electrode conductivity, and any electrically conductive material may be utilized as a conductive material unless it causes a chemical change. Examples of the conductive material include a carbon-based material such as natural graphite, artificial graphite, carbon black, acetylene black, ketjen black, a carbon fiber and/or the like; a metal-based material of a metal powder or a metal fiber including copper, nickel, aluminum, silver, and/or the like; a conductive polymer such as a polyphenylene derivative; and/or mixturesHe thereof.

The current collector may be an aluminum foil, a nickel foil, or a combination thereof, but the present disclosure is not limited thereto.

The positive active material layer and the negative active material may be prepared by mixing the active material, the binder and optionally, the conductive material in a solvent to prepare an active material composition and coating the active material composition on the current collector.

Such an active material layer preparation method is generally available in the related art so that the detailed description may not be provided in detail herein. The solvent may be N-methyl pyrrolidone, and/or the like, but the present disclosure is not limited thereto. If the aqueous binder is utilized in the negative active material layer, water may be utilized as a solvent utilized in the negative active material composition preparation.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, propyl propionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. Furthermore, the ketone-based solvent may include cyclohexanone, and/or the like. In one or more embodiments, the alcohol-based solvent may include ethanol, isopropyl alcohol, and/or the like, and the aprotic solvent may include nitriles such as R—CN (where R is a C2 to C20 linear, branched, or cyclic hydrocarbon, and may include a double bond, an aromatic ring, or an ether bond), amides such as dimethylformamide, and/or the like, dioxolanes such as 1,3-dioxolane, 1,4-dioxolane, and/or the like, sulfolanes, and/or the like.

The organic solvent may be utilized alone or in a mixture. If the organic solvent is utilized in a mixture, the mixture ratio may be controlled or selected in accordance with a desirable battery performance and it may be generally available to one in related art.

Furthermore, the carbonate-based solvent may include a mixture with a cyclic carbonate and a linear carbonate. The cyclic carbonate and linear carbonate are mixed together in a volume ratio of about 1:1 to about 1:9, and if the mixture is utilized as an electrolyte, it may have enhanced performance.

If the non-aqueous organic solvents are mixed and utilized, a mixed solvent of cyclic carbonate and linear carbonate, a mixed solvent of cyclic carbonate and a propionate-based solvent, or a mixed solvent of cyclic carbonate, linear carbonate and a propionate-based solvent may be utilized. The propionate-based solvent may include methyl propionate, ethyl propionate, propyl propionate, or a combination thereof.

Herein, if a mixture of cyclic carbonate and linear carbonate, or a mixture of cyclic carbonate and propionate-based solvent is utilized, it may be desirable to utilize it with a volume ratio of about 1:1 to about 1:9 considering the performances. Furthermore, cyclic carbonate, linear carbonate and a propionate-based solvent may be mixed and utilized at a volume ratio of 1:1:1 to 3:3:4. The mixing ratio of the solvents may be also appropriately adjusted according to the desired or suitable properties.

The non-aqueous organic solvent may further include an aromatic hydrocarbon-based solvent as well as the carbonate-based solvent. Herein, the carbonate-based solvent and the aromatic hydrocarbon-based solvent may be mixed together in a volume ratio of about 1:1 to about 30:1.

The aromatic hydrocarbon-based organic solvent may be an aromatic hydrocarbon-based compound represented by Chemical Formula 1.

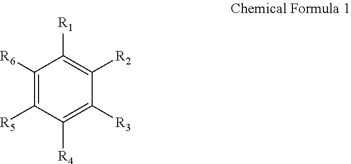

In Chemical Formula 1, R₁ to R₆ may each independently be the same or different and are (e.g., are selected from) hydrogen, a halogen, a C1 to C10 alkyl group, a haloalkyl group, and/or a combination thereof.

Specific examples of the aromatic hydrocarbon-based organic solvent may be (e.g, may be selected from) benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and/or combinations thereof.

The electrolyte may further include vinylene carbonate, or an ethylene carbonate-based compound represented by Chemical Formula 2, as an additive for improving life cycle characteristics.

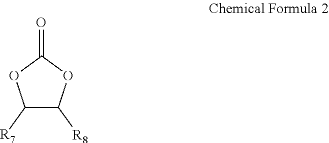

In Chemical Formula 2, R₇ and R& may each independently be the same or different and may each independently be hydrogen, a halogen, a cyano group (CN), a nitro group (NO₂), or a C1 to C5 fluoroalkyl group, provided that at least one of R₇ and R₈ is a halogen, a cyano group (CN), a nitro group (NO₂), or a C1 to C5 fluoroalkyl group, and R₇ and R₈ are not concurrently (e.g., simultaneously) hydrogen.

Examples of the ethylene carbonate-based compound may include difluoro ethylenecarbonate, chloroethylene carbonate, dichloroethylene carbonate, bromoethylene carbonate, dibromoethylene carbonate, nitroethylene carbonate, cyanoethylene carbonate, or fluoroethylene carbonate, and/or the like. In cases of further utilizing the additive for improving life cycle characteristics, the utilized amount thereof may be appropriately adjusted.

The electrolyte may further include vinylethylene carbonate, propane sultone, succinonitrile, or a combination thereof, and herein, the utilized amount may be suitably adjusted.

The lithium salt dissolved in an organic solvent supplies a battery with lithium ions, basically operates the rechargeable lithium battery, and improves transportation of the lithium ions between positive and negative electrodes. Examples of the lithium salt may include one or two of (e.g., one or two selected from) LiPF₆, LiBF₄, LiSbF₆, LiAsF₆, LIN(SO₂C₂F₅)₂, Li(CF₃SO₂)₂N, LIN(SO₃C₂F₅)₂, Li(FSO₂)₂N (lithium bis(fluorosulfonyl)imide: LiFSI), LiC₄F₉SO₃, LiClO₄, LIAlO₂, LiAlCl₄, LIPO₂F₂, LIN(CₓF₂ₓ₊₁SO₂)(C_{y}F_{2y+1}SO₂), (where x and y are natural numbers, for example integers of 1 to 20), lithium difluoro(bisoxolato) phosphate, LiCl, Lil, LiB(C₂O₄)₂ (lithium bis(oxalato) borate: LiBOB) and/or lithium difluoro(oxalate) borate (LiDFOB), as a supporting electrolytic salt. A concentration of the lithium salt may range from about 0.1 M to about 2.0 M. If the lithium salt is included at the above concentration ranges, an electrolyte may have excellent or suitable performance and lithium ion mobility due to optimal or suitable electrolyte conductivity and viscosity.

The lithium secondary battery may further include a separator between the negative electrode and the positive electrode, depending on a kind of the battery. Examples of a separator material include polyethylene, polypropylene, polyvinylidene fluoride, and multi-layers having two or more layers thereof such as a polyethylene/polypropylene double-layered separator, a polyethylene/polypropylene/polyethylene triple-layered separator, and a polypropylene/polyethylene/polypropylene triple-layered separator.

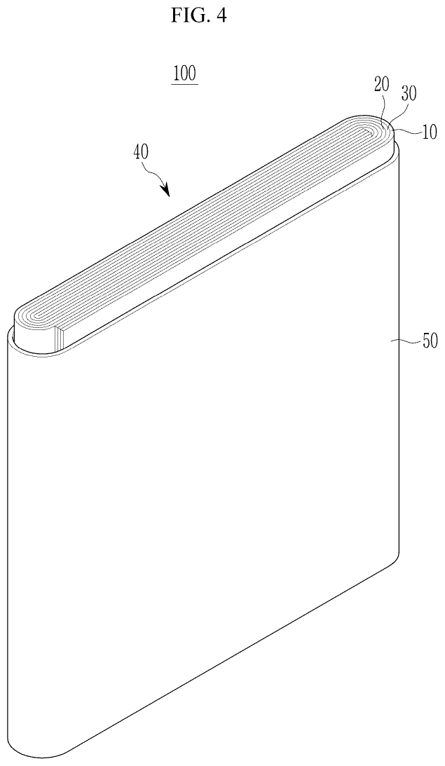

FIG. 4 is an exploded perspective view of a rechargeable lithium battery according to one or more embodiments of the present disclosure. The rechargeable lithium battery according to one or more embodiments is illustrated as a prismatic battery, but the present disclosure is not limited thereto and may include variously-shaped batteries such as a cylindrical battery, a pouch battery, and/or the like.

Referring to FIG. 4, a rechargeable lithium battery 100 according to one or more embodiments may include an electrode assembly 40 manufactured by winding a separator 30 disposed between a positive electrode 10 and a negative electrode 20 and a case 50 housing the electrode assembly 40. An electrolyte may be impregnated in the positive electrode 10, the negative electrode 20 and the separator 30.

Hereinafter, examples of the present disclosure and comparative examples are described. These examples, however, are not in any sense to be interpreted as limiting the scope of the present disclosure.

### 1 Example 1

5 wt % of a Si-based negative active material including a silicon core and a soft carbon amorphous carbon layer positioned on the core, 92 wt % of artificial graphite, 2 wt % of a styrene butadiene rubber binder and 1 wt % of a carboxymethyl cellulose thickener were mixed in a water (i.e., aqueous) solvent to prepare a first negative active material layer slurry, with a viscosity of 3000 cps (at 25° C.).

5 wt % of a Si-based negative active material including a silicon core and a soft carbon amorphous carbon layer positioned on the core, 91 wt % of artificial graphite, 2 wt % of a styrene butadiene rubber binder and 2 wt % of a carboxymethyl cellulose thickener were mixed in a water solvent to prepare a second negative active material layer slurry, with a viscosity of 3000 cps (at 25° C.). The first negative active material layer slurry was coated on a Cu foil without applying the magnetic field, and dried to prepare a first negative active material layer with a thickness of 15 μm.

Thereafter, the Cu foil on which the first negative active material layer was formed was disposed on a magnet having a magnetic field strength of 6000 Gauss, while the Cu foil was moved, the second negative active material slurry was coated on the first negative active material layer to expose it to a magnetic field for 10 seconds, and dried to prepare a second negative active material layer with a thickness of 80 μm, thereby obtaining a negative electrode.

96 wt % of a LiCoO₂ positive active material, 2 wt % of a carbon black conductive agent, and 2 wt % of a polyvinylidene fluoride binder were mixed in an N-methyl pyrrolidone solvent to prepare a positive active material slurry. The slurry was coated on an Al current collector, dried, and pressurized to prepare a positive electrode.

Using the negative electrode, the positive electrode, and an electrolyte, a rechargeable lithium cell (full cell) was fabricated. The electrolyte was prepared by utilizing a mixed solvent of ethylene carbonate and diethyl carbonate (50:50 of a volume ratio) and dissolving 1.5 M LiPF₆ therein.

### Example 2

5 wt % of a Si-based negative active material including a silicon core and a soft carbon amorphous carbon layer positioned on the core, 91 wt % of artificial graphite, 2 wt % of a styrene butadiene rubber binder and 2 wt % of a carboxymethyl cellulose thickener were mixed in a water solvent to prepare a first negative active material layer slurry, with a viscosity of 3000 cps (at 25° C.).

5 wt % of a Si-based negative active material including a silicon core and a soft carbon amorphous carbon layer positioned on the core, 91 wt % of artificial graphite, 2 wt % of a styrene butadiene rubber binder and 2 wt % of a carboxymethyl cellulose thickener were mixed in a water solvent to prepare a second negative active material layer slurry, with a viscosity of 3000 cps (at 25° C.).

The first negative active material layer slurry was coated on a Cu foil without applying a magnetic field, and dried to prepare a first negative active material layer with a thickness of 15 μm.

Thereafter, the Cu foil on which the first negative active material layer was formed was disposed on a magnet having a magnetic field strength of 6000 Gauss, while the Cu foil was moved, the second negative active material slurry was coated on the first negative active material layer to expose a magnetic field for 8 seconds, and dried to prepare a second negative active material layer with a thickness of 80 μm, thereby obtaining a negative electrode.

Using the negative electrode, and the positive electrode and the electrolyte utilized in Example 1, a rechargeable lithium cell was fabricated by substantially the same procedure as in Example 1.

### Example 3

5 wt % of a Si-based negative active material including a silicon core and a soft carbon amorphous carbon layer positioned on the core, 91 wt % of artificial graphite, 2 wt % of a styrene butadiene rubber binder and 2 wt % of a carboxymethyl cellulose thickener were mixed in a water solvent to prepare a first negative active material layer slurry, with a viscosity of 3000 cps (at 25° C.).

5 wt % of a Si-based negative active material including a silicon core and a soft carbon amorphous carbon layer positioned on the core, 91 wt % of artificial graphite, 2 wt % of a styrene butadiene rubber binder and 2 wt % of a carboxymethyl cellulose thickener were mixed in a water solvent to prepare a second negative active material layer slurry, with a viscosity of 3000 cps (at 25° C.).

The first negative active material layer slurry was coated on a Cu foil without applying a magnetic field, and dried to prepare a first negative active material layer with a thickness of 15 μm.

Thereafter, the Cu foil on which the first negative active material layer was formed was disposed on a magnet having a magnetic field strength of 6000 Gauss, while the Cu foil was moved, the second negative active material slurry was coated on the first negative active material layer to expose a magnetic field for 5 seconds, and dried to prepare a second negative active material layer with a thickness of 80 μm, thereby obtaining a negative electrode.

Using the negative electrode, and the positive electrode and the electrolyte utilized in Example 1, a rechargeable lithium cell was fabricated by substantially the same procedure as in Example 1.

### Comparative Example 1

After the Cu foil was disposed on a magnet having a magnetic field strength of 6000 Gauss, while the Cu foil was moved, the first negative active material slurry according to Example 1 was coated on the Cu foil to expose a magnetic field for 10 seconds, and dried to prepare a negative active material layer with a thickness of 80 μm. The resulting product was utilized as a negative electrode.

Using the negative electrode, and the positive electrode and the electrolyte utilized in Example 1, a rechargeable lithium cell was fabricated by substantially the same procedure as in Example 1.

### Comparative Example 2

5 wt % of a Si-based negative active material including a silicon core and a soft carbon amorphous carbon layer positioned on the core, 91 wt % of artificial graphite, 2 wt % of a styrene butadiene rubber binder and 2 wt % of a carboxymethyl cellulose thickener were mixed in a water solvent to prepare a first negative active material layer slurry, with a viscosity of 3000 cps (at 25° C.).

5 wt % of a Si-based negative active material including a silicon core and a soft carbon amorphous carbon layer positioned on the core, 91 wt % of artificial graphite, 2 wt % of a styrene butadiene rubber binder and 2 wt % of a carboxymethyl cellulose thickener were mixed in a water solvent to prepare a second negative active material layer slurry, with a viscosity of 3000 cps (at 25° C.).

After the Cu foil was disposed on a magnet with a magnetic field strength of 6000 Gauss, while the Cu foil was moved, the first negative active material slurry was coated on the Cu foil to expose a magnetic field for 8 seconds, and dried to prepare a first negative active material layer with a thickness of 15 μm.

Thereafter, the second negative active material layer slurry was coated on the first negative active material layer and exposed to a magnetic field for 10 second, followed by drying to prepare a second negative active material layer with a thickness of 80 μm, thereby obtaining a negative electrode.

Using the negative electrode, and the positive electrode and the electrolyte utilized in Example 1, a rechargeable lithium cell was fabricated by substantially the same procedure as in Example 1.

### Comparative Example 3

5 wt % of a Si-based negative active material including a silicon core and a soft carbon amorphous carbon layer positioned on the core, 91 wt % of artificial graphite, 2 wt % of a styrene butadiene rubber binder and 2 wt % of a carboxymethyl cellulose thickener were mixed in a water solvent to prepare a first negative active material layer slurry, with a viscosity of 3000 cps (at 25° C.).

5 wt % of a Si-based negative active material including a silicon core and a soft carbon amorphous carbon layer positioned on the core, 91 wt % of artificial graphite, 2 wt % of a styrene butadiene rubber binder and 2 wt % of a carboxymethyl cellulose thickener were mixed in a water solvent to prepare a second negative active material layer slurry, with a viscosity of 3000 cps (at 25° C.).

After the Cu foil was disposed on a magnet having a magnetic field strength of 6000 Gauss, while the Cu foil was moved, the first negative active material slurry was coated on the Cu foil to expose a magnetic field for 10 seconds, and dried to prepare a first negative active material layer with a thickness of 15 μm.

Thereafter, the magnet was removed, under the condition of no applied magnetic field (by the magnet), the second negative active material layer slurry was coated on the first negative active material layer, dried and pressurized, to prepare a negative active material layer, thereby obtaining a negative electrode.

Using the negative electrode, and the positive electrode and the electrolyte utilized in Example 1, a rechargeable lithium cell was fabricated by substantially the same procedure as in Example 1.

### Experimental Example 1) Measurement of X-Ray Diffraction Characteristic

The rechargeable lithium cells according to Example 1 to 3 and Comparative Examples 1 to 3 were charged and discharged at 0.1 C twice, and fully discharged at 0.1 C to 2.75 V. The fully-discharged battery cells were disassembled to obtain negative electrodes. As for these negative electrodes, X′Pert (PANalytical B.V.) XRD equipment utilizing a CuKα ray as a target ray was utilized, but monochromator equipment was removed in order to improve a peak intensity resolution, and then an XRD was measured. Herein, the measurement was performed under a condition of 2θ=10° to 80°, a scan speed (°/S)=0.06436, and a step size of 0.026°/step.

From the measured XRD results, the DD values of each of the layers were calculated, and the results are shown in Table 1.

The areas of the peaks shown at 2θ=26.5±0.2° ((002) plane), 42.4±0.2° ((100) plane), 43.4±0.2° ((101) R plane), 44.6±0.2° ((101) H plane), 54.7±0.2° ((004) plane), and 77.5±0.2° ((110) plane) were measured, and the area sum of peaks shown at 2θ=42.4±0.2° ((100) plane), 43.4±0.2° ((101)R plane), 44.6±0.2° ((101)H plane), and 77.5±0.2° ((110) plane) as Iₐ, and the area sum of peaks shown at 2θ=26.5±0.2° ((002) plane), 42.4±0.2° ((100) plane), 43.4±0.2° ((101)R plane), 44.6±0.2° ((101)H plane), 54.7±0.2° ((004) plane), and 77.5±0.2° ((110) plane) as Iₜₒₜₐₗ, and DD (Iₜₒₜₐₗ/la) was obtained by calculating from these values.

From the DD values of the first and second negative active material layers, an A value expressed in Equation 1 was measured. The results are shown in Table 1.

$$A \geq 10 \qquad Equation 1$$

In Equation 1, the A is a DD value of the second negative active material layer—a DD value of the first negative active material layer.

TABLE 1

| | DD value of first | DD value of second | |
|---|---|---|---|
| | negative active | negative active | |
| | material layer | material layer | A |
| Example 1 | 24 | 46 | 22 |
| Example 2 | 20 | 35 | 15 |
| Example 3 | 20 | 30 | 10 |
| Comparative | 48 (oriented single layer) | | 0 |
| Example 1 | | | |
| Comparative | 40 | 46 | 6 |
| Example 2 | | | |
| Comparative | 46 | 24 | −22 |
| Example 3 | | | |

As shown in the Table 1, the negative electrodes according to Examples 1 to 3 in which only the second negative active material layer was formed under the condition of applying a magnetic field had the A value of 10 to 22. However, the negative electrode according to Comparative Example 2 in which the first and second negative active material layers were both formed under the condition of applying a magnetic field had the A value of 6, which was very low. Furthermore, in Comparative Example 3, as the first negative active material layer was formed under the condition of applying a magnetic field, the DD value of the first negative active material was larger than the DD value of the second negative active material layer, and resultantly, the A value was found to be −22.

### Experimental Example 2) Evaluation of the Thickness of the Negative Electrode

The thicknesses of the negative electrodes according to Examples 1 to 3 and Comparative Examples 1 to 3 were measured. Furthermore, the rechargeable lithium cells according to Examples 1 to 3 and Comparative Examples 1 to 3 were charged under a SOC30 (charged to be 30% of charge capacity based on 100% of entire battery charge capacity), the negative electrode was disassembled from the cell, and then the thickness of the negative electrode was measured.

The thickness of the negative electrode before charge and discharge is shown as a pressurization, and the thickness of the negative electrode after charge and discharge is shown as a SOC30 in Table 2.

TABLE 2

| | Pressurization | | Thickness |
|---|---|---|---|
| | (μm) | SOC30 (μm) | increase rate (%) |
| Example 1 | 192.3 | 221.7 | 15.3 |
| Example 2 | 193 | 223 | 15.5 |
| Example 3 | 193.5 | 221 | 14.2 |
| Comparative | 193.9 | Sever | Impossible to |
| Example 1 | | separation | measure |
| Comparative | 193.1 | Sever | Impossible to |
| Example 2 | | separation | measure |
| Comparative | 193.6 | 228.3 | 17.9 |
| Example 3 | | | |

As shown in Table 2, the negative electrodes according to Examples 1 to 3 in which the A value were 10 or more, exhibited the thickness increase rate of 14.2% to 15.3%, as the repeated charge and discharge. Meanwhile, Comparative Example 1 with an oriented single layer or Comparative Example 2 with an A value of 6 exhibited the severe separation of the negative active material layer during charge and discharge, and thus, it was impossible to measure the thickness increase rate. In addition, Comparative Example 3, in which the first negative active material layer was an oriented layer, also exhibited a high thickness increase rate.

### Experimental Example 3) Measurement of Expansion Rate

The rechargeable lithium cells according to Examples 1 to 3 and Comparative Examples 1 to 3 were charged and discharged at 1C under a condition of SOC100 (fully charge, charged to be 100% of charge capacity based on 100% of entire battery charge capacity). A ratio of the cell thickness after full charge to the cell thickness before charge and discharge was measured. The results are shown in Table 3 as an expansion rate.

TABLE 3

| | Expansion rate (%) |
|---|---|
| Example 1 | 18.5 |
| Example 2 | 19.2 |
| Example 3 | 20.4 |
| Comparative Example 1 | Separation |
| Comparative Example 2 | Separation |
| Comparative Example 3 | 22.4 |

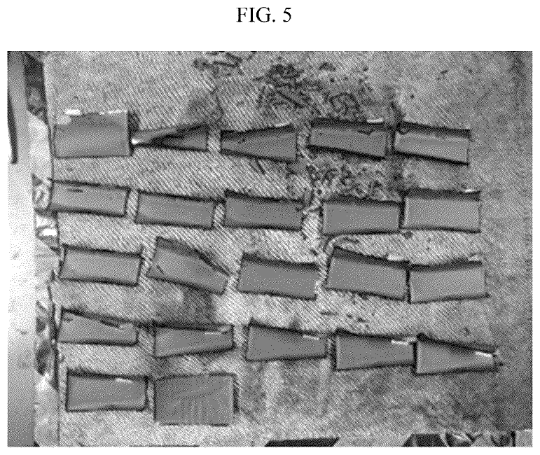

Among the results, the separation state of the negative electrode of Comparative Example 2 after fully-charging is shown in FIG. 5. Comparative Example 2 with the A value of 6 in Equation 1 caused the separation of the negative active material layer, as shown in FIG. 5.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Further, the use of “may” when describing embodiments of the present disclosure refers to “one or more embodiments of the present disclosure.”

As used herein, the term “and/or” includes any and all combinations of one or more of the associated listed items.

As used herein, the term “substantially,” “about,” and similar terms are used as terms of approximation and not as terms of degree, and are intended to account for the inherent deviations in measured or calculated values that would be recognized by those of ordinary skill in the art. “Substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within ±30%, 20%, 10%, 5% of the stated value.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

The portable device, vehicle, and/or the battery, e.g., a battery controller, and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Although the embodiments of the present disclosure have been described, it is understood that the present disclosure should not be limited to these embodiments, but one or more suitable changes and modifications can be made by one ordinary skilled in the art within the spirit and scope of the present disclosure as defined by the following claims and equivalents thereof.

What is claimed is:

1. A negative electrode for a rechargeable lithium battery, the negative electrode comprising:
a current collector;
a first negative active material layer on at least one surface of the current collector; and
a second negative active material layer on the first negative active material layer,
wherein,
the first negative active material layer is a non-oriented layer, and the second negative active material layer is an oriented layer,
wherein a DD (Degree of Divergence) value of the first negative active material layer and a DD value of the second negative active material layer have a relationship expressed in Equation 1:
$$A \geq 10 \qquad Equation 1$$
wherein, in Equation 1, A is the DD value of the second negative active material layer—the DD value of the first negative active material layer,
wherein the DD value is defined by Equation 2:
$$DD ( Degree of Divergence ) = ( {I}_{a} / {I}_{total} ) * 100 , \qquad Equation 2$$
and
wherein in Equation 2, Iₐ is a sum of peak intensities at non-planar angles measured by XRD utilizing a CuKα ray, and Iₜₒₜₐₗ is a sum of peak intensities at all angles measured by XRD utilizing a CuKα ray.

2. The negative electrode as claimed in claim 1, wherein A is about 10 to about 40.

3. The negative electrode as claimed in claim 1, wherein the DD value of the first negative active material layer is less than about 30.

4. The negative electrode as claimed in claim 1, wherein the DD value of the first negative active material layer is less than about 30, and about 10 or more.

5. The negative electrode as claimed in claim 1, wherein the DD value of the second negative active material layer is about 30 or more.

6. The negative electrode as claimed in claim 1, wherein the DD value of the second negative active material layer is about 30 to about 60.

7. The negative electrode as claimed in claim 1, wherein the first negative active material layer has a thickness of about 10 μm to about 30 μm.

8. The negative electrode as claimed in claim 1, wherein Iₐ is the sum of peak intensities at 2θ=42.4±0.2°, 43.4±0.2°, 44.6±0.2°, and 77.5±0.2° measured by XRD utilizing the CuKα ray, and
Iₜₒₜₐₗ is the sum of peak intensities at 2θ=26.5±0.2°, 42.4±0.2°, 43.4±0.2°, 44.6±0.2°, 54.7±0.2°, and 77.5±0.2° measured by XRD utilizing the CuKα ray.

9. The negative electrode as claimed in claim 1, wherein the peak intensities at the non-planar angles and the peak intensities at all the angles are peak integral area values.

10. The negative electrode as claimed in claim 1, wherein the first negative active material layer or the second negative active material layer comprises a crystalline carbon-based negative active material.

11. The negative electrode as claimed in claim 1, wherein the first negative active material layer or the second negative active material layer comprises a crystalline carbon-based negative active material and a Si-based negative active material.

12. The negative electrode as claimed in claim 11, wherein a mixing ratio of the crystalline carbon-based negative active material and the Si-based negative active material is about 98:2 to about 90:10 in a weight ratio.

13. The negative electrode as claimed in claim 11, wherein the Si-based negative active material is Si, a Si—C composite, SiOₓ (0<x<2), Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof but not Si), or a combination thereof.

14. A rechargeable lithium battery, comprising:
the negative electrode of claim 1;
a positive electrode comprising a positive active material; and
a non-aqueous electrolyte.
